(19) United States
(12) Patent Application Publication
(10) Pub. No.: US 2018/0030818 A1
(43) Pub. Date: Feb. 1, 2018

(54) RETROFIT POWER SWITCHING AND REPEATING MODULE

(71) Applicant: GE Oil & Gas UK Limited, Bristol (GB)

(72) Inventor: Matthew Edmund STONE, Nailsea, Bristol (GB)

(21) Appl. No.: 15/551,449

(22) PCT Filed: Feb. 4, 2016
(86) PCT No.: PCT/EP2016/052332

§ 371 Date: Aug. 16, 2017

(30) Foreign Application Priority Data
Feb. 16, 2015 (GB) 1502566.1

(51) Int. Cl. E21B 43/01; H02G 9/00; G05B 15/02; H02G 1/14

(52) U.S. Cl. CPC E21B 43/01; H02G 1/14; H02G 9/00; G05B 15/02

(57) ABSTRACT

A power switching module including: a plurality of input interfaces; a plurality of output interfaces; a plurality of switches connected between respective ones of the input interfaces and the output interfaces; and a controller operable to selectively open and close the switches, wherein the power switching module is received in a marinised canister.

### BACKGROUND OF THE INVENTION

This invention relates to a power switching module, for example, for use in a subsea system. The invention also relates to a method of retrofitting a subsea system with a power switching module.

In subsea systems, such as those used for operating an underwater hydrocarbon extraction facility, it is often desirable to switch power on and off to specific components in the system. In existing fields, the subsea equipment may have been deployed without the capability of power switching individual components. The removal and redeployment of subsea systems is a complex and time-consuming procedure, and often cannot be economically justified on fields approaching the end of their useful lifespan. As these assets age, it may become useful to be able to isolate individual areas of the system for retrieval and rework. Therefore, it would be useful to be able to retrofit power switching and repeating solutions into existing subsea systems (for example, using a remotely operated underwater vehicle or an autonomous underwater vehicle). This philosophy can extend to adding other new features of the system, supported by the retro-insertion technologies mentioned in this document.

### SUMMARY OF THE INVENTION

In accordance with one aspect of the present invention there is provided a power switching module, the power switching module comprising: a plurality of input interfaces; a plurality of output interfaces; a plurality of switches connected between respective ones of the input interfaces and output interfaces; and a controller operable to selectively open and close the switches, wherein the power switching module is received in a marinised canister.

In accordance with another aspect of the present invention there is provided a method of retrofitting a subsea system, said subsea system comprising a plurality of power lines connected to respective powered components of the subsea system, with a power switching module, said module being received in a marinised canister and comprising a plurality of input interfaces, a plurality of output interfaces, a plurality of switches connected between respective ones of the input interfaces and the output interfaces, and a controller operable to selectively open and close the switches, the method comprising the steps of: disconnecting the plurality of power lines from their respective components; connecting the plurality of power lines to respective ones of the input interfaces; and providing a plurality of power lines between respective ones of the output interfaces and the components of the subsea system.

The controller may be connected to a communications input interface and a communications output interface for a dedicated communications line. In this case, the controller could be configured to receive a control signal from the communications input interface.

The controller may be in electrical communication with the plurality of input interfaces and the plurality of output interfaces. In this case, the controller could be configured to receive a control signal from one of the input interfaces.

The control signal could optionally be a communication on power signal.

The control signal could optionally be a modulated power signal. In this case, the modulated power signal could be a pulsed frequency signal or a pulsed phase signal.

The power switching module could be retrofitted into a subsea system, which could optionally form part of a subsea hydrocarbon extraction facility.

### BRIEF DESCRIPTION OF THE DRAWINGS

The invention will now be described by way of example with reference to the accompanying drawings, in which:

FIG. 1 schematically shows a power switching module;

FIG. 2 schematically shows a power switching module; and

FIG. 3 schematically shows a power switching module.

### DETAILED DESCRIPTION

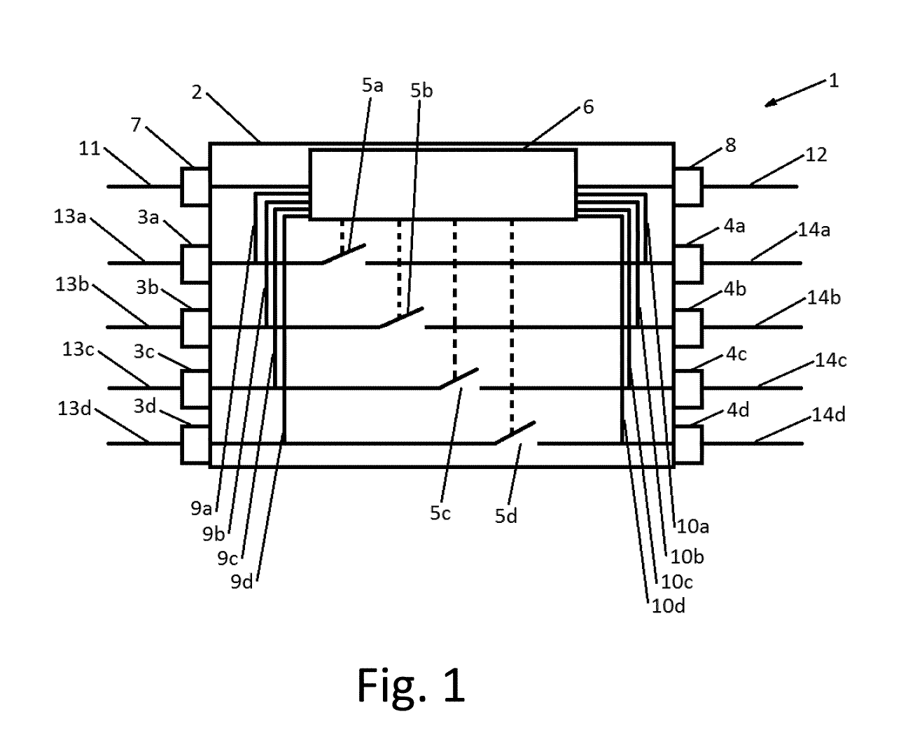

FIG. 1 schematically shows a power switching module 1 according an embodiment of the invention.

The power switching module 1 comprises a canister 2 which contains switching technology. The canister 2 is a marinised canister, i.e. it is watertight and ruggedized to ensure a long lifespan in a harsh underwater environment. A first side of the canister 2 comprises a plurality of input interfaces 3a, 3b, 3c and 3d. The canister 2 further comprises a plurality of corresponding output interfaces 4a, 4b, 4c and 4d on an opposite side to the first side. A plurality of switches 5a, 5b, 5c and 5d are connected between respective ones of the input interfaces and output interfaces.

The power switching module 1 further comprises a controller 6 which is operable to selectively open and close each of the switches 5a-d. The power switching module 1 further comprises a communications input interface 7 and a communications output interface 8, each in electrical communication with the controller 6. If a subsea system includes a dedicated communications line 11, this can be attached to the communications input interface 7 as shown. The controller 6 can then receive a control signal from the communications input interface 7 which controls which of the switchable electrical connectors 5a-d are to be connected/disconnected. The controller 6 can pass any communications signals received at the communications input interface 7 to the output interface 8 for further dissemination to other components in the subsea system via a further communications line 12. However, communications output interface 8 may be omitted entirely if the dedicated communications line 11 is a spare communications line in the system, or if the communications signals received are not required by any components downstream of the power switching module 1.

The controller 6 is in electrical communication with each of the input interfaces 3a-d via electrical connectors 9a, 9b, 9c and 9d, and with each of the output interfaces 4a-d via electrical connectors 10a, 10b, 10c and 10d. If the subsea system does not include a dedicated communications line 11 as shown, the controller 6 can receive a control signal from the one of the power lines connected to the input interfaces 3a-d. Various methodologies may be used to transmit a control signal over a power line. For example, a communication on power signal (COPS) may be used. Alternatively, the power signal may be modulated, e.g. the frequency or phase of the power signal may be pulsed using a modulator located at the power source. Said power source may be located topside, or at a subsea facility.

In FIG. 1 it is assumed that the power switching module 1 is incorporated into a subsea system, i.e. with a retrofit operation having already been performed. In this state, a plurality of power lines 13a, 13b, 13c and 13d from a subsea cable termination assembly (for example, an umbilical termination assembly) have been disconnected from their respective components of the subsea system and connected to each of the input interfaces 3a-d. New power lines 14a, 14b, 14c and 14d are attached between the output interfaces 4a-d which connect the power switching module 1 to components of a subsea system (for example, a hydrocarbon production system), to which the power lines of the cable termination assembly were attached prior to the retrofit operation being performed.

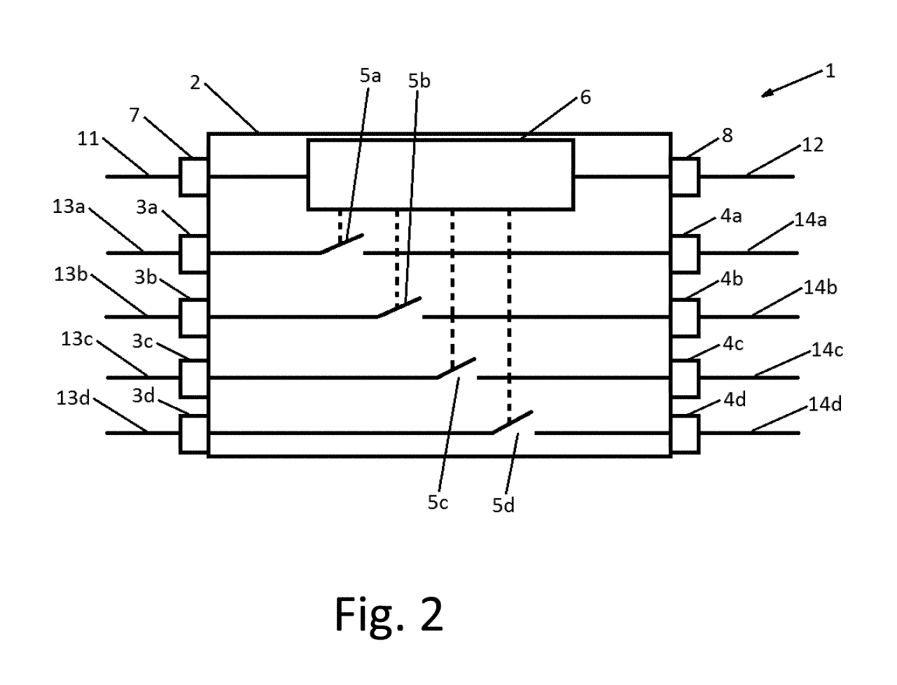

FIG. 2 schematically shows a power switching module 1 according to an embodiment of the invention. Like reference numerals from FIG. 1 have been retained as appropriate.

The power switching module 1 shown in FIG. 2 is identical to that of FIG. 1, except that the electrical connectors 9a-d and 10a-d have been removed. In situations where it is known that there is a dedicated communications line 11, these electrical connectors can be omitted from the canister 2 resulting in a simplified power switching module.

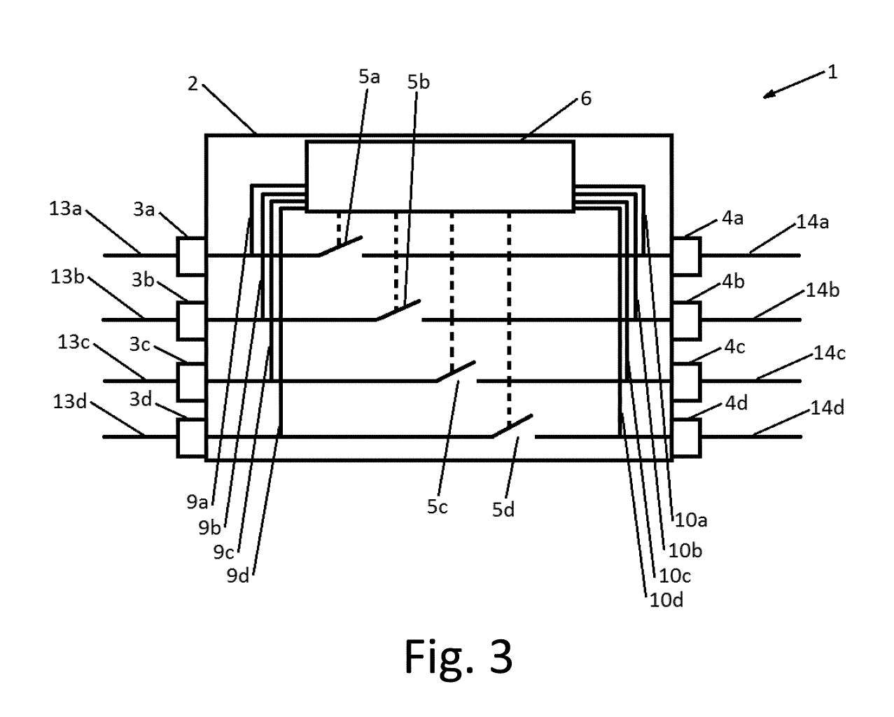

FIG. 3 schematically shows a power switching module 1 according to an embodiment of the invention. Like reference numerals from FIG. 1 have been retained as appropriate.

The power switching module 1 shown in FIG. 3 is identical to that of FIG. 1, except that the communications input interface 7 and the communications output interface 8, and the electrical connections between the controller 6 and the communications input and output interfaces 7 and 8, have been removed. In situations where it is known that the subsea system to be retrofitted includes no dedicated communications line, these interfaces and electrical connections can be omitted from the canister 2 resulting in a simplified power switching module.

The embodiment shown in FIG. 1 is an embodiment of the invention, as it can be retrofitted into subsea systems that include a dedicated communications line, and also into subsea systems that do not include a dedicated communications line. When the embodiment shown in FIG. 1 is used in a subsea systems that includes a dedicated communications line, the electrical connectors 9a-d and 10a-d can still act to provide an emergency back-up means of communicating with the controller 6 in the event that communications input interface 7 or the dedicated communications line 11 fails.

There are numerous advantages associated with embodiments of the present invention. For example, the power switching module can be retrofitted into a legacy subsea installation to provide individual line isolation. This can provide more detailed control of a subsea installation in situations where the existing system only has the ability to disconnect the power supply to entire installation, and not individual components thereof.

The invention is not limited to the specific embodiments disclosed above, and other possibilities will be apparent to those skilled in the art.

For example, while a single controller is shown in the embodiments of FIGS. 1 to 3, the power switching module could comprise respective discrete controllers for each power line, or a linked set of controllers.

Additionally, while the embodiments of FIGS. 1 to 3 show four input interfaces and four output interfaces, any number of input and output interfaces may be used in practice.

Additionally, while the communications input and output interfaces are described as being electrically connected to the controller, the use of other methods of transmitting the control signal are not precluded, and fall within the scope of the invention. For example, the dedicated communications line could be an optical fibre, and the communications input/output interfaces could be in optical communication with the controller. Alternatively, an optical signal being received at the communications input interface could be converted to an electrical signal using an electrical—optical data converter (EODC). This electrical signal could be converted back into an optical signal using an EODC at the communications output interface for further transmission to components of a subsea system.

In embodiments of the invention where there is a dedicated communications line, the power switching module could optionally become a new node of the subsea system. This would be particularly useful if it proved desirable to deploy sensors in the power switching module, for example, temperature sensors to monitor any active electronics within the module. This would also be useful if it proved desirable to deploy power line conditioning and monitoring technologies within the module, for example, insulation resistance monitoring means, in a single combined retrofit package. Alternatively, the power switching module could optionally remain ‘transparent’ to the system, merely acting as a repeater for communications signals to and from the components of the subsea system.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A power switching module, the power switching module comprising:
a plurality of input interfaces;
a plurality of output interfaces;
a plurality of switches connected between respective ones of the input interfaces and output interfaces; and
a controller operable to selectively open and close the switches,
wherein the power switching module is received in a marinised canister.

2. The power switching module according to claim 1, wherein the controller is connected to a communications input interface and a communications output interface for a dedicated communications line.

3. The power switching module according to claim 2, wherein the controller is configured to receive a control signal from the communications input interface.

4. The power switching module according to claim 1, wherein the controller is in electrical communication with the plurality of input interfaces and the plurality of output interfaces.

5. The power switching module according to claim 4, wherein the controller is configured to receive a control signal from one of the input interfaces.

6. The power switching module according to claim 5, wherein the control signal is a communication on power signal.

7. The power switching module according to claim 5, wherein the control signal is a modulated power signal.

8. The power switching module according to claim 7, wherein the modulated power signal is a pulsed frequency signal.

9. The power switching module according to claim 8, wherein the modulated power signal is a pulsed phase signal.

10. The power switching module according to claim 1, wherein the power switching module is located in a system.

11. The power switching module according to claim 10, wherein the subsea system forms part of an underwater hydrocarbon extraction facility.

12. A method of retrofitting a subsea system, the subsea system comprising a plurality of power lines connected to respective powered components of the subsea system, with a power switching module, the module being received in a marinised canister and comprising a plurality of input interfaces, a plurality of output interfaces, a plurality of switches connected between respective ones of the input interfaces and the output interfaces, and a controller operable to selectively open and close the switches, the method comprising the steps of:
disconnecting the plurality of power lines from their respective components;
connecting the plurality of power lines to respective ones of the input interfaces; and
providing a plurality of power lines between respective ones of the output interfaces and the components of the subsea system.

13. The method according to claim 12, wherein the controller is connected to a communications input interface and a communications output interface for a dedicated communications line.

14. The method according to claim 13, wherein the controller is configured to receive a control signal from the communications input interface.

15. The method according to claim 12, wherein the controller is in electrical communication with the plurality of input interfaces and the plurality of output interfaces.

16. The method according to claim 15, wherein the controller is configured to receive a control signal from one of the input interfaces.

17. The method according to claim 16, wherein the control signal is a communication on power signal.

18. The method according to claim 16, wherein the control signal is a modulated power signal.

19. The method according to claim 18, wherein the modulated power signal is a pulsed frequency signal.

20. The method according to claim 18, wherein the modulated power signal is a pulsed phase signal.

21. The method according to claim 12, wherein the subsea system forms part of an underwater hydrocarbon extraction facility.
